(19) United States
(12) Patent Application Publication
(10) Pub. No.: US 2018/0202222 A1
(43) Pub. Date: Jul. 19, 2018

(54) Chain Tensioner for Roller Blind

(71) Applicant: ZMC Metal Coating Inc., Woodbridge (CA)

(72) Inventor: Philip Ng, Thornhill (CA)

(21) Appl. No.: 15/852,354

(22) Filed: Dec. 22, 2017

Related U.S. Application Data
(60) Provisional application No. 62/447,949, filed on Jan. 19, 2017.

(51) Int. Cl. E06B 9/324; E06B 9/325

(52) U.S. Cl. CPC E06B 9/324; E06B 9/326; E06B 9/325

(57) ABSTRACT

The locking tensioner comprises first and second elongate arms connected by a bridge. The distal end of the second arm has a tongue. The distal end of the first arm has a head with an aperture dimensioned to receive a chain therethrough, the head further having a slot dimensioned to releasably receive the tongue within the aperture. The second arm is pivotable relative to the first arm between a locked and an unlocked configuration. In the unlocked configuration, the tongue is disposed in the aperture to permit the chain to move through the aperture. In the locked configuration, the tongue applies a shear force between the chain and the head to restrict the movement of the chain. The bridge biases the first and second arms towards the locked configuration.

### FIELD

This invention relates generally to roller blinds, or roller shades, and in particular to a new and novel locking tensioner for a cord or chain of a roller blind or roller shade.

### BACKGROUND

One common form of window shade or window covering comprises a fabric or other material that is wound upon a roller that is fixed or mounted to the top portion of the window frame. The fabric can be pulled downwardly and unrolled from the roller in order to block or minimize the amount of light infusion through the window. When it is desired to allow unrestricted light to pass through the window, the fabric is typically wound back onto the roller through the use of one of a wide variety of different mechanical mechanisms.

Most commonly, a looped rope, cord or chain is operatively connected to the roller through the use of a clutch. Pulling on one of the “legs” of the rope, cord or chain will typically cause the clutch to impart rotational movement to the roller in a first direction, which will either unwind the fabric from the roller or rewind the fabric back onto the roller. Similarly, pulling downwardly on the other “leg” of the rope, cord or chain will cause the roller to rotate in the opposite direction. Since the roller and the clutch mechanism will be mounted at the top of the blind, and at the top of window frame, in many cases a relatively long cord or chain is required, particularly for windows or openings of a substantial vertical height. Unfortunately, long looped ropes, cords or chains have been found to present strangulation hazards for small children, and sometimes pets.

As a result of the potential for children and/or pets to become entangled about long loops of chain or cord hanging from a roller blind, a number of jurisdictions have legislated regulations stipulating that, when properly installed, the roller blind must not operate unless a cord tensioner is in place. Such cord or chain tensioners must be fastened to a wall or window frame in order to hold the cord or chain tightly against the side of the wall or window frame and to eliminate or substantially reduce the likelihood of a child becoming entangled in the cord or chain. From a blind operational perspective, the tensioner must hold the two legs of the looped cord relatively parallel in order to ensure a smooth operation of the clutch mechanism. In some jurisdictions, regulations further stipulate that the tensioner must effectively render the roller blind inoperable should the tensioner not be secured to a wall or frame, or should it at some point become detached from the wall or window frame.

### SUMMARY

There is therefore provided a locking tensioner for a roller blind, the roller blind of the type having a roller and a looped chain or cord to impart rotational movement to the roller, the locking tensioner comprising first and second elongate arms connected at a first end by a bridge, each of the first and second arms having a longitudinal axis and a distal second end. The distal end of the second arm has an outwardly extending tongue generally aligned with the longitudinal axis of the second arm. The distal end of the first arm has a head with an aperture dimensioned to receive the chain or chord therethrough, the head further having a slot dimensioned to releasably receive the tongue to permit the tongue to be received within the aperture. The second arm is pivotable relative to the first arm between a locked and an unlocked configuration. When the locking tensioner is in the unlocked configuration, the tongue is disposed in the aperture to permit the chain or cord to move through the aperture. When the locking tensioner is in the locked configuration, the tongue applies a shear force between the chain or cord and the head to restrict the movement of the chain or cord through the aperture. The bridge biases the first and second arms towards the locked configuration.

There is also provided a locking tensioner for a roller blind, the roller blind of the type having a roller and a looped chain or cord to impart rotational movement to the roller, the locking tensioner comprising first and second elongate arms connected at a first end by a bridge, each of the first and second arms having a longitudinal axis and a distal second end. The distal end of the second arm has an outwardly extending tongue generally aligned with the longitudinal axis of said second arm. The distal end of the first arm has a head with an aperture dimensioned to receive the chain or chord therethrough, the head further having a slot dimensioned to releasably receive the tongue to permit the tongue to be received within the aperture. The second arm is pivotable relative to the first arm between a locked and an unlocked configuration. When the locking tensioner is in the unlocked configuration, the tongue is disposed in the aperture to permit the chain or cord to move through the aperture. When the locking tensioner is in the locked configuration, the tongue applying a shear force between the chain or cord and the head to restrict the movement of the chain or cord through the aperture. The bridge biases the first and second arms towards the locked configuration, and the tongue is arcuate with a concave surface that generally conforms to the curvature of the aperture. When the locking tensioner is secured by a fastener, the tongue is fully received within the head such that the concave surface of the tongue is generally aligned with the interior surface of the aperture so that the tongue does not interfere with the movement of the chain or cord through the aperture.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a front view of a window frame having mounted thereon a roller blind utilizing a locking tensioner in accordance with the present invention.

FIG. 2 is an upper side perspective view of FIG. 1.

FIG. 3 is a side perspective view of a locking tensioner constructed in accordance with an embodiment of the present invention.

FIG. 4 is a rear perspective view of the locking tensioner of FIG. 3.

FIG. 5 is an enlarged view of portion A of FIG. 1 wherein the tensioner is in an unlocked configuration.

FIG. 6 is a view of the locking tensioner of FIG. 5 in a locked configuration wherein the tensioner is partially detached from the window frame, thereby locking the rope, cord or chain of the roller blind.

FIG. 7 is a side perspective view of the locking tensioner of FIG. 4 engaging a window blind chain.

FIG. 8 is a side plan view of the locking tensioner of FIG. 7.

FIG. 9 is cross-section view along line B-B of FIG. 8.

FIG. 10 is cross-section view along line C-C of FIG. 8.

FIG. 11 is a front perspective view of a window frame having mounted thereon an alternate embodiment of the locking tensioner of the present invention.

FIG. 12 is a front perspective view of the locking tensioner of FIG. 11.

FIG. 13 is a back perspective view of the locking tensioner of FIG. 12 engaging a window blind chain.

FIG. 14 is a side plan view of the locking tensioner of FIG. 13.

FIG. 15 is cross-section view along line D-D of FIG. 14.

### DESCRIPTION

The present invention may be embodied in a number of different forms. The specification and drawings that follow describe and disclose some of the specific forms of the invention.

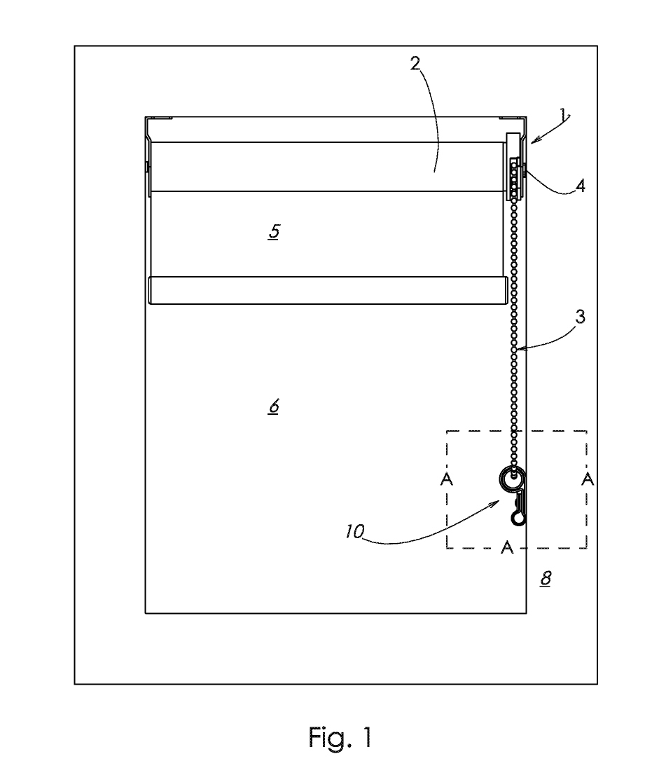

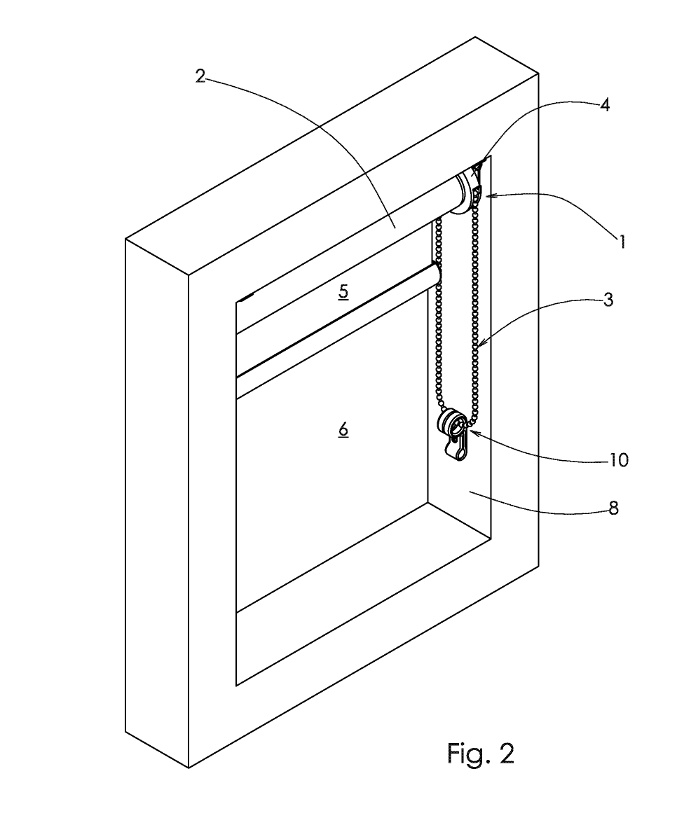

Referring to the attached drawings, and particularly FIGS. 1 and 2, there is shown a generic roller blind 1 of the type having a roller 2 and a looped chain or cord 3 to impart rotational movement to the roller. Typically, the chain or cord will be in a continuous loop and received about a clutch or drive mechanism 4 that imparts rotational movement to the roller in either a clockwise or counter-clockwise direction, depending on which leg of the chain or cord is pulled in a downward fashion. In that matter, blind fabric 5 can either be lowered in front of window 6 or retracted back on to roller 2.

For purposes of safety, and in many cases to comply with local jurisdictional regulations, the roller blind will include a locking tensioner 10. One of the primary purposes of locking tensioner 10 is to hold the chain or cord 3 taughtly and securely to the frame of window 6, or in some cases to an adjacent wall 8 or other fixed or rigid structure.

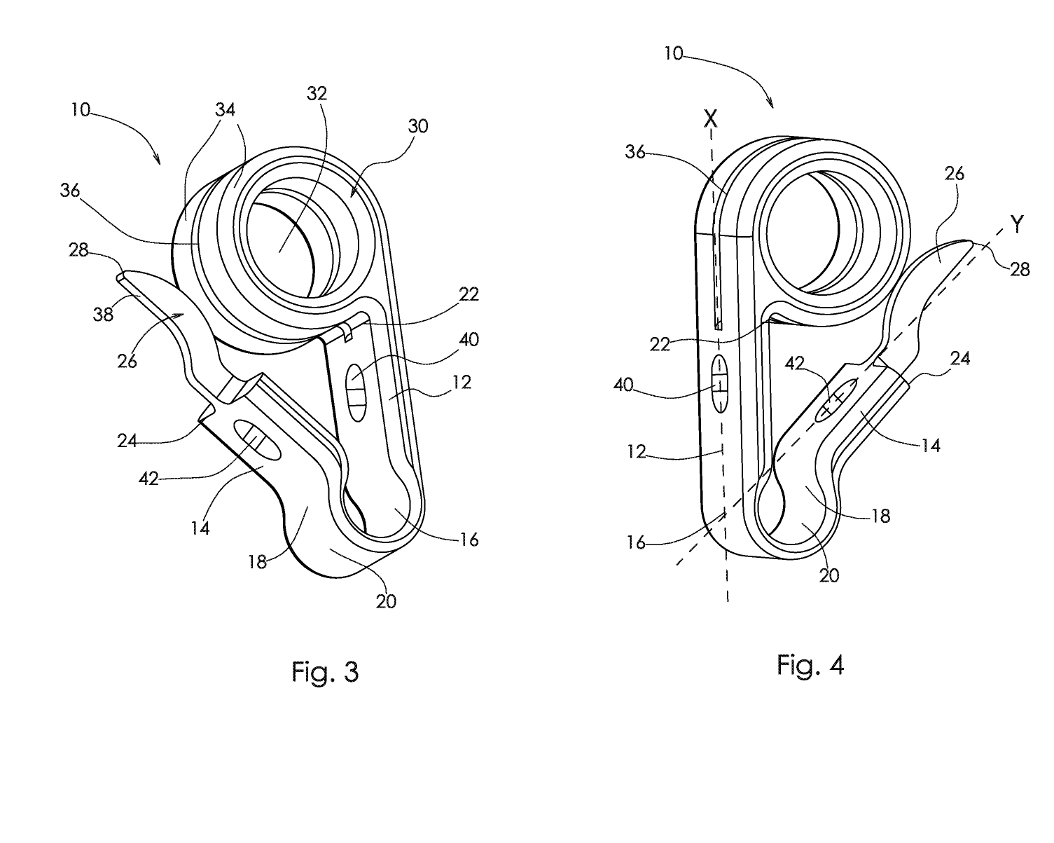

With specific reference to FIGS. 3 through 8, locking tensioner 10 includes first and second elongate arms 12 and 14. As best seen in FIGS. 3 and 4, first and second arms 12 and 14 are pivotably secured to one another by a bridge 20 at their first ends 16 and 18, respectively. Each of first and second arms 12 and 14 further has a distal second end 22 and 24, respectively. First arm has longitudinal axis X and second arm has longitudinal axis Y.

As best seen in FIGS. 3 and 4, distal second end 24 of second arm 14 has an outwardly extending tongue 26 with a tip 28. Tongue 26 is generally aligned with longitudinal axis Y of second arm 14.

Distal second end 22 of first arm 12 has a head 30 with an aperture 32 having a generally arcuate interior surface. Aperture 32 is dimensioned to receive the chain or chord therethrough. In the depicted embodiment, head 30 includes a pair of loop members 34, which are aligned with the longitudinal axis X of first arm 12. Loop members 34 are further spaced apart to define a slot 36 therebetween.

Slot 36 is dimensioned to releasably receive tongue 26 to permit tongue 26 to be received within aperture 30. Tongue 26 is also dimensioned to be slidably received within slot 34 between loop members 34. Tongue 26 is further arcuate in shape with a concave surface 38 that generally conforms to the curvature of the interior surface of aperture 32.

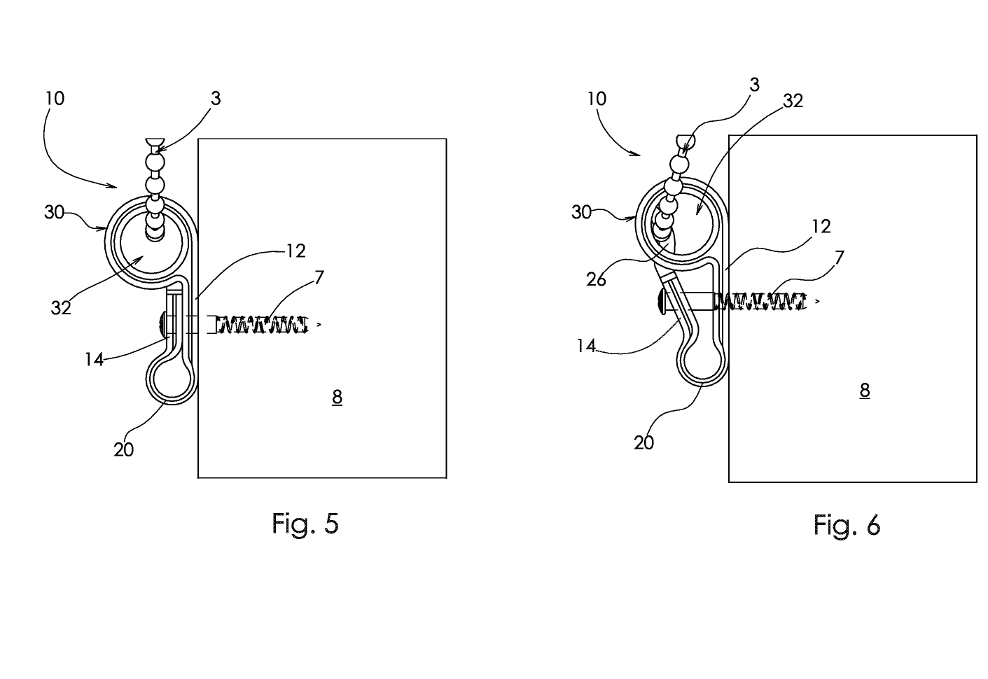

First and second arms 12 and 14 further have openings 40 and 42 for the passage of a fastener 7 (see FIGS. 5 and 6) therethrough to secure locking tensioner 10 to window frame or wall 8.

The functionality and operation of locking tensioner 10 will now be described in further detail. As shown in the attached Figures, second arm 14 is pivotable relative to first arm 12 between an unlocked configuration (FIG. 5) and a locked configuration (FIGS. 6-8). In the embodiment depicted, bridge 20 is made from a flexible resilient material which pivotably biases first and second arms 12 and 14 towards the locked configuration.

In the unlocked configuration, locking tensioner 10 is secured to window frame 8 by fastener 7 (for example, a screw), wherein second arm 14 is generally aligned with, and overlying, first arm 12. In this way, tongue 26 is disposed in aperture 32 to permit chain or cord 3 to move through aperture 32, and to permit normal operation of the roller blind. In the embodiment shown in FIG. 5, the tongue is fully received within head 30 such that the concave surface of the tongue is generally aligned with the arcuate interior surface of aperture 32 and, thus, hidden from view. In the unlocked configuration, therefore, the tongue does not interfere with the movement of chain or cord 3 through aperture 32.

Should for any reason fastener 7 become detached or partially detached from window frame 8, the force from fastener 7 counter-acting the action of bridge 20 will be either minimized or removed, causing second arm 14 to pivot relative to first arm 12. Locking tensioner 10 will thus move from its unlocked configuration to its locked configuration, shown in FIG. 6.

This causes tongue 26 to bear against chain or cord 3, thereby applying a shear force between chain or cord 3 and head 30 which restricts movement of chain or cord 3 through aperture 32. It will be thus appreciated that a loosening of fastener 7 (or its complete removal from window frame 8) will cause locking tensioner 10 to move from its unlocked to its locked configuration, thereby rendering the roller blind inoperable until such time as fastener 7 is re-secured to window frame 8.

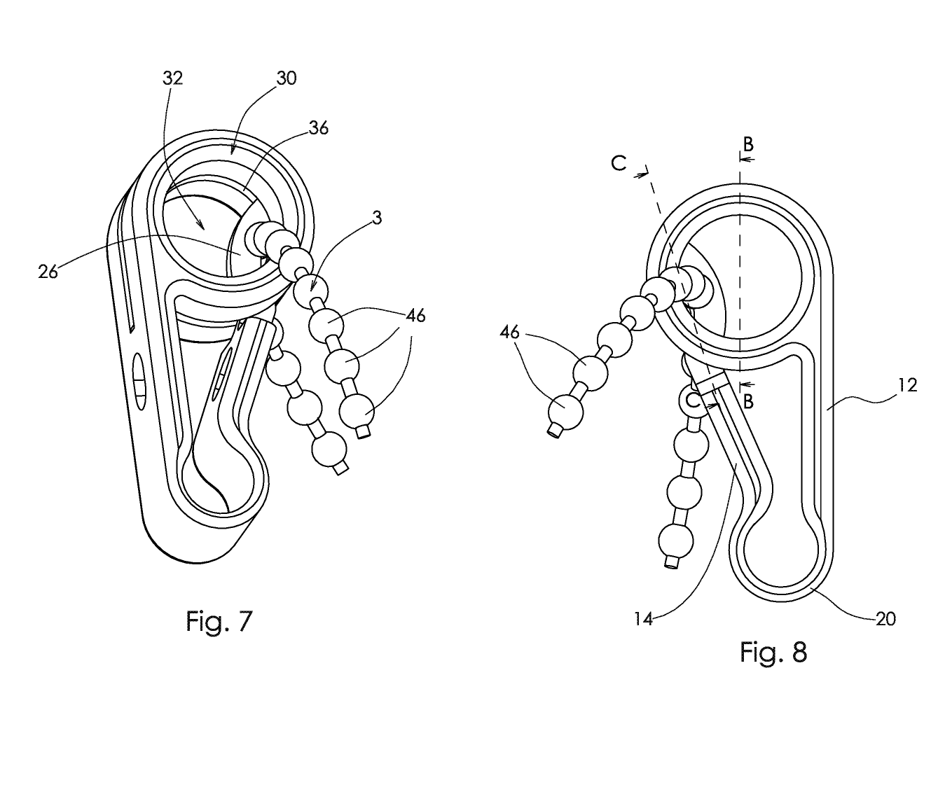

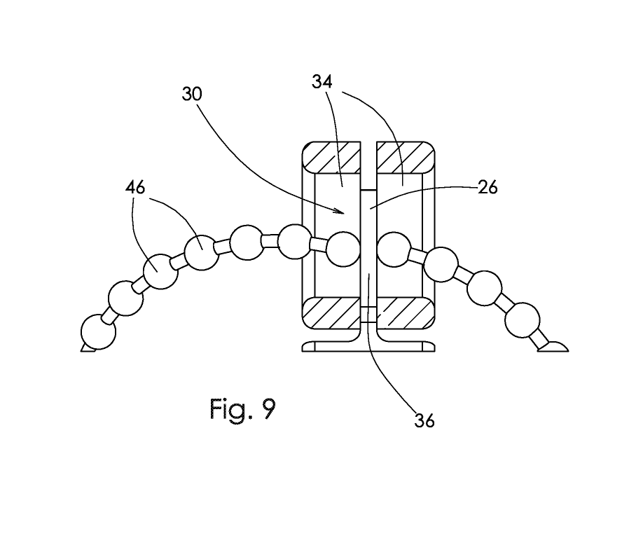

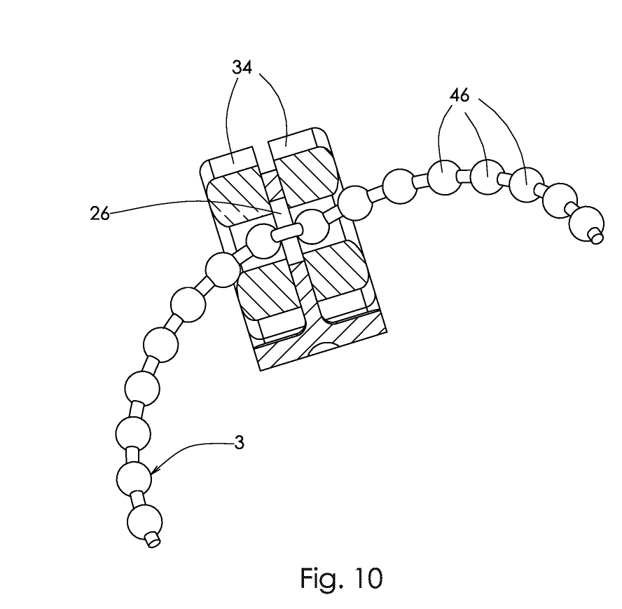

In the embodiment depicted in FIGS. 7 and 8, chain or cord 3 includes generally evenly spaced apart beads 46. As best seen in FIGS. 9 and 10, the width of tongue 26 is dimensioned to fit between adjacent beads 46. In this way, when tongue 26 is biased towards the locked configuration, tongue 26 tends to engage the chain or cord between adjacent beads 46, thereby further helping to restrict movement of chain or cord 3 through aperture 32. Given the arcuate shape of tongue 26, the tip (not shown) is disposed within slot 36 when locking tensioner 10 is in the locked configuration, as seen in FIGS. 7 and 8. In this manner, side loading of tongue 26 on account of its placement between adjacent beads 46 is accommodated by the loop member against which tip 28 bears.

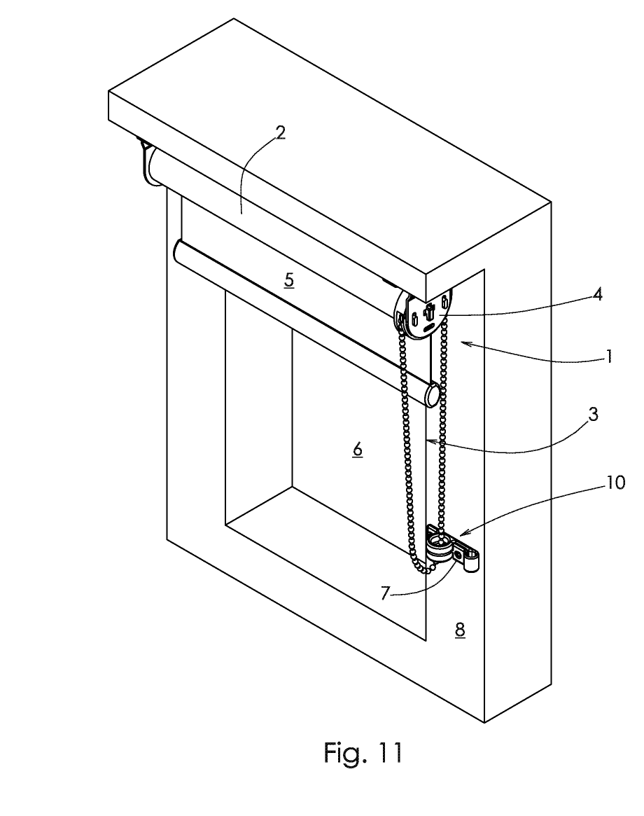

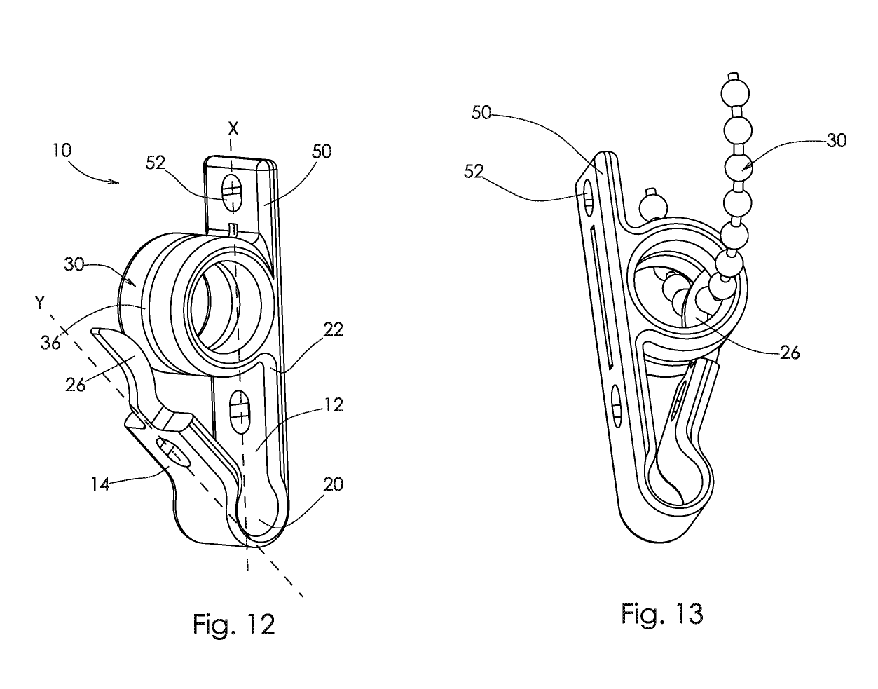

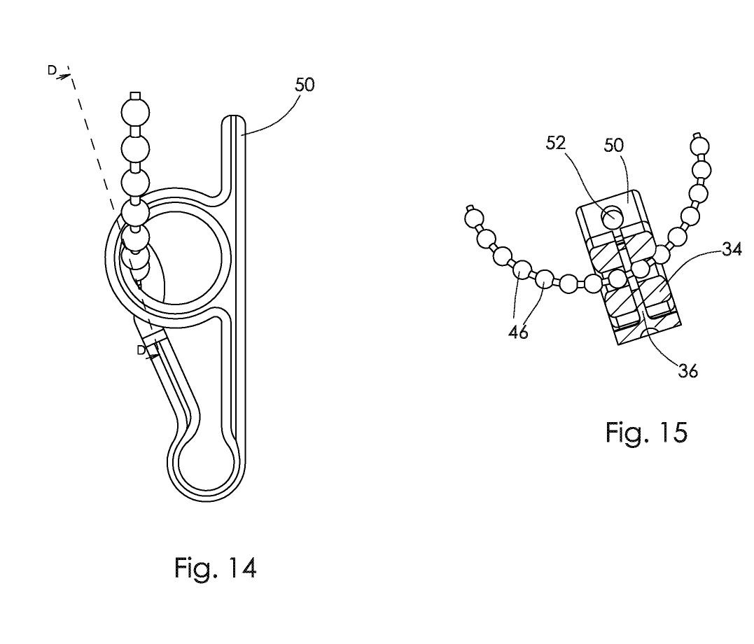

FIGS. 11 through 15 show an alternate embodiment of the invention that is essentially parallel in terms of its operation and function to that shown in FIGS. 1 through 10. In the embodiment depicted in FIGS. 11-15, second end 22 of first arm 12 further includes an attachment portion 50 generally aligned with longitudinal axis X of first arm 12 and connected to head 30. Attachment portion 50 has an additional hole or slot 52 for the passage of an additional fastener (not shown) to secure locking tensioner 10 to window frame 8.

It is to be understood that what has been described are some of the preferred embodiments of the invention. The scope of the claims should not be limited by the embodiments set forth above, but should be given the broadest interpretation consistent with the description as a whole.

I claim:

1. A locking tensioner for a roller blind, the roller blind of the type having a roller and a chain or cord to impart rotational movement to the roller, the locking tensioner comprising:
first and second elongate arms connected at a first end by a bridge, each of the first and second arms having a longitudinal axis and a distal second end,
the distal end of the second arm having an outwardly extending tongue generally aligned with the longitudinal axis of said second arm,
the distal end of the first arm having a head with an aperture dimensioned to receive the chain or chord therethrough, the head further having a slot dimensioned to releasably receive the tongue to permit the tongue to be received within the aperture,
the second arm pivotable relative to the first arm between a locked and an unlocked configuration, when in the unlocked configuration the tongue is disposed in the aperture to permit the chain or cord to move through the aperture, when in the locked configuration the tongue applying a shear force between the chain or cord and the head to restrict the movement of the chain or cord through the aperture,
the bridge biasing the first and second arms toward the locked configuration.

2. The locking tensioner as claimed in claim 1 wherein the head generally includes a pair of loop members, the loop members aligned with the longitudinal axis of the first arm and spaced apart to define the slot therebetween.

3. The locking tensioner as claimed in claim 2 wherein the tongue is dimensioned to be slidably received within the slot between the loop members.

4. The locking tensioner as claimed in claim 3 wherein the chain includes spaced apart beads, the width of the tongue dimensioned to fit between adjacent beads of the chain.

5. The locking tensioner as claimed in claim 4 wherein the tongue has an anterior tip, in the locked configuration the tip is disposed within the slot and between the loop members.

6. The locking tensioner as claimed in claim 1 wherein each of the first and second arms have an opening for the passage of a first fastener therethrough, the second arm generally aligned and generally overlying the first arm when the locking tensioner is in the unlocked configuration and permitting the first fastener to be received through the respective openings in first and second arms to secure the locking tensioner to a window frame or wall.

7. The locking tensioner as claimed in claim 5, wherein the tongue is arcuate with a concave surface that generally conforms to the curvature of the aperture.

8. The locking tensioner as claimed in claim 7 wherein, when in said unlocked configuration, the tongue is fully received within the head such that the concave surface of the tongue is generally aligned with the interior surface of the aperture so that the tongue does not interfere with the movement of the chain or cord through the aperture.

9. The locking tensioner as claimed in claim 7, wherein the distal end of the first arm further includes an attachment portion aligned with the longitudinal axis of the first arm, the attachment portion having a hole or slot therein for the passage of a second fastener therethrough for securing the locking tensioner to a window frame or wall.

10. A locking tensioner for a roller blind, the roller blind of the type having a roller and a chain or cord to impart rotational movement to the roller, the locking tensioner comprising:
first and second elongate arms, each connected at a first end by a bridge, each of the first and second arms having a longitudinal axis and a distal second end,
the distal end of the second arm having an outwardly extending tongue generally aligned with the longitudinal axis of said second arm,
the distal end of the first arm having a head with an aperture having a generally arcuate interior surface dimensioned to receive the chain or chord therethrough, the head further having a slot dimensioned to releasably receive the tongue to permit the tongue to be received within the aperture,
the second arm pivotable relative to the first arm between a locked and an unlocked configuration, when in the unlocked configuration the tongue disposed in the aperture permitting the chain or cord to move through the aperture, when in the locked configuration the tongue applying a shear force between the chain or cord and the head to limit the movement of the chain or cord through the aperture,
the bridge biasing the first and second arms toward the locked configuration, and
the tongue being arcuate with a concave surface that generally conforms to the curvature of the interior surface of the aperture.

11. The locking tensioner as claimed in claim 10, wherein when the locking tensioner is secured to a surface, the tongue is fully received within the head such that the concave surface of the tongue is generally aligned with the interior surface of the aperture so that the tongue does not interfere with the movement of the chain or cord through the aperture.

12. The locking tensioner as claimed in claim 10, wherein each of the first and second arms have an opening for the passage of a fastener therethrough, the second arm generally aligned and generally overlying the first arm when the locking tensioner is in the unlocked configuration and permitting the fastener to be received through the respective openings in said first and second arms to secure the locking tensioner to a window frame or wall.

13. The locking tensioner as claimed in claim 10, wherein the head includes a pair of loop members, the loop members aligned with the longitudinal axis of the first arm and spaced apart to define the slot therebetween.

14. The locking tensioner as claimed in claim 13 wherein the tongue is dimensioned to be slidably received within the slot between the loop members.

15. The locking tensioner as claimed in claim 10 wherein the chain includes spaced apart beads, the width of the tongue dimensioned to fit between adjacent beads of the chain.

16. The locking tensioner as claimed in claim 14 wherein the tongue has an anterior tip, wherein in the locked configuration, the tip is disposed within the slot and between the loop members.
